(19) United States
(12) Patent Application Publication
(10) Pub. No.: US 2009/0152380 A1
(43) Pub. Date: Jun. 18, 2009

(54) Wildlife Repellent Dispersal System and Apparatus

(76) Inventors: Raymond Houseknecht, Massapequa, NY (US); Shane Thomas Eckardt, East Hampton, NY (US)

Correspondence Address: RAYMOND HOUSEKNECHT, 88 CONNECTICUT AVE., MASSAPEQUA, NY, 11758, US

(21) Appl. No.: 11/956,557

(22) Filed: Dec. 14, 2007

(51) Int. Cl. B05B 1/02

(52) U.S. Cl. 239/390

(57) ABSTRACT

This invention provides a means to distribute any fluid-based substance (repellent) in a 360-degree pattern, over a large diameter coverage area, intended to dissuade wildlife, namely deer, from destroying plants, trees, flowers or the like. The invention is a self-sufficient unit which can be placed anywhere without the dependence on electric outlets, running water or solar clearance for purposes of electricity. This invention has a built-in programmable timer which can be set to activate and deactivate the unit for any duration of time while maintaining a weekly schedule and enabling the user to specify the routine that suits them the best. The device dispenses the repellent as often as the user desires per the programmable digital timer in order to protect the plant life within that zone. This unit is discreetly designed with multiple interlocking tubular sections that provide for adjustment in order to reach the height of operation that best suits the items the user wishes to protect from said wildlife.

### BACKGROUND OF THE INVENTION

1. Field of the Invention

The present invention relates to a wildlife repellent system and apparatus and more specifically a new and more comprehensive, aesthetically pleasing, affordable and user-friendly means to protect the plant life that deer and other forms of wildlife destroy by their direct proximal presence.

2. Background Art

Currently their exists very few reliable options for the property owner to ward off wildlife and specifically deer from devouring their plants, small trees, flowers and shrubs. With ever expanding development, these animals don't have to travel far to find a veritable buffet of plant life in peoples' backyards. In only one evening, a few deer can cause thousands of dollars in damage by way of their appetite. On an annual basis it's estimated that the total damage is far into the millions in the United States alone.

There are a myriad of sprays and solutions available on the market today, many of which deter deer from eating the treated plant life, however their effectiveness is short lived due to precipitation and morning dew which dilutes these substances over a short period of time. A property owner can choose to buy a hand held pump sprayer or hand pumped nozzle head to treat the plants he or she desires to protect, however the process is tedious and unpleasant to say the least. Besides the annoyance of frequent reapplications (bi weekly in most instances to fully protect the intended target) these substances detract deer for a certain reason; they are foul smelling and often downright disgusting. Most of the effective solutions on the market today contain animal urine, rotten egg enzymes and hot pepper derivatives. It's no surprise why these ingredients often render the plants unpalatable for their predator. Thus it also comes as no surprise that property owners are averse to handling these products more than they absolutely have to.

This catch 22 creates the problem and thus the need for this device. Since people dread handling and applying the current products that indeed do work and since the continual reapplication process is tedious, they often simply do not do it enough. Therefore this lapse results in a chink in the armor for the deer and wildlife to exploit resulting in plant damage. This invention bridges the gap between the repellent and the application and eliminates the property owner as the middleman therefore solving the dilemma at hand.

Prior art has provided a number of solutions to remedy the aforementioned problem however no examples have taken all variables into account including practicality and cost effectiveness to create a truly successful and marketable product.

U.S. Pat. No. 5,602,523 issued Feb. 11, 1997 to Turchioe, et al. uses an audio frequency that is unpleasant to the deer and certain forms of wildlife. This frequency is variable to overcome the previous pitfall of audio deterrents in which deer become accustomed to the sound after a certain period of time and resume their damaging ways. However despite this variable, there is no proof that these frequencies will not affect pets or animals the property owner does not wish to repel. In addition, there is also no consideration made for background noise created by weather or nature that could drown out the audio signals, making the plants an easy target.

U.S. Pat. No. 6,745,950 issued Jun. 8, 2004 to Longo and U.S. Pat. No. 4,953,763 issued Sep. 4, 1990 to Kierum, et al. both consist of apparatus for dispersing/dispensing animal scent into the proximity of the device. These examples of prior art are primarily intended to dispense a scent intended to attract deer or other forms of wildlife for which hunters or trappers would receive the benefit of. However, it is mentioned that either of these devices could also be used as a deterrent if the scent which these products dispense were switched to a repellent rather than an attractant. However these products or similar examples of prior art primarily use porous membranes, pressurized sprays, or gravity fed drips to dispense said scent. These products rely more upon an animal's sense of smell and not on their sense of taste. Therefore if their preferred embodiment were to be to repel an animal with these examples of prior art, their means would be relegated and the effectiveness of the physical deterrent would be compromised.

U.S. Pat. Application No. 20070095941 filed Nov. 3, 2005 and last revised May 3, 2007 by Gorres, consists of a self-contained unit that can be operated by a plurality of types of motorized pumps and power sources. This unit is also intended to be self-sufficient and operable independent of electrical outlets or running water however the main shortfall of this example of prior art lies in its method of repellent delivery. Regardless of the means this prior art chooses to embody in order to propel the repellent, the nozzle is affixed to the top of the invention (or in a singular place for that matter). Therefore the spray of repellent must be focused in one direction. Even if the preferred embodiment was to focus the spray opposite the ground, the diameter of coverage would be marginal at best and also be contingent upon external factors such as wind direction and height at which the user chooses to place the apparatus (which this example of prior art does not provide a component for adjustment of). Furthermore, the capabilities of a spray nozzle are limited as far volume of propellant that can be dispensed in the respect that in order to increase the coverage diameter, the nozzle must be adjusted further to a mist setting at the expense of the volume of repellent dispensed. Regardless, the coverage area achieved is insufficient for its intended purpose.

U.S. Pat. Application No. 20050158352 filed Jan. 16, 2004 and last revised Jul. 21, 2005 by Bell, describes a device which deters wildlife, namely deer, from invading and devouring a property owner's plant life by triggering all five senses associated with an animal's natural defenses. This example of prior art contends that although previous prior art has focused on one or two of the senses, the only “foolproof” way to deter the animal is to stimulate all five senses. However, there are a few problems inherent in this example of prior art. The first is feasibility. The inventor claims to have an apparatus which will be activated through motion sensors and which will direct blasts of foul smelling/tasting substances, sprays of water, blasts of sound and a beam of light at the approaching animal via these motion sensors. Although this sounds impressive, its functionality is unlikely due to the properties inherent of motion detectors. If this example of prior art were to embody an infrared motion detector (one that is based upon heat signatures) then there is no guarantee that the household pets would not trigger the device. The rapid release of the product propelled by the pressurized air would give the pets no time to retreat. This would then create a whole new set of problems when the vile deer repellent is brought into the home on the coats of the pets thus creating the need to have them bathed repeatedly. Secondly, this example of prior art is unavoidably impractical. To have all the components claimed work correctly would make for an exorbitantly expensive device. The common user will need more than one of these devices to adequately protect their intended investment and the cost of the protection would be higher than the cost of the damage itself. Furthermore, the possibility for this prior art to function independent of a subterranean compressed air line leading to a standard compressor is also unlikely. To be able to constantly administer blasts of water and repellent for a sustained period of time in the range specified, would require a large volume of air that is not available in the form of a portable cartridge and if there were one it would have to be changed frequently. In either instance, this example of prior art would severely lack marketability.

Therefore, in light of the shortcomings of the aforementioned examples of prior art, it became apparent that there existed a need for a better-designed wildlife deterrent apparatus. This factor gave rise to an invention which operates independent of external sources, including electricity, running water or the need for solar clearance for purposes of electricity all the while doing so in a functional, practical, marketable and aesthetically pleasing fashion.

### SUMMARY OF THE INVENTION

The present invention possesses functionality to meet multiple objectives associated with mitigating the burgeoning wildlife, namely deer, property damage issue at hand.

The first object of the present invention is to be aesthetically pleasing. The design is comprised of four basic components structured strategically to achieve the aforementioned object: The repellent container, the weatherproof housing, the adjustable height tubing and the 360-degree rotating dispenser head.

The container is composed of polypropylene or a material with similar properties and possesses a flat bottom and a curved low profile stance intended to hug the weatherproof housing on one side and also aid in the stability of the device by providing a counterpoint for the ground stake. There is a nylon sheath encompassing the entire container with a Velcro top which has two cutouts: One for the wide mouth refill cap and the other for the repellent tube fitting. The nylon cloth sheath serves two functions. Firstly, it provides a blank canvas for a plethora of design options that would best suit the present invention's place of operation in addition to the branding location for the product. Secondly it provides an adhesion point for the weatherproof housing via a polypropylene insert that is placed between the container and the nylon sheath. The container is positioned at ground level on the device so as to use the surrounding undergrowth in which it is placed, to screen the invention's only conspicuous however necessary component.

The second contributing factor to the present invention's aesthetics is the weatherproof housing in which all of the electrical components are stored including the rotary pump, battery pack and programmable digital timer. The weatherproof box will be composed of PVC or a material with similar properties and can be painted or pre-tinted in the injection molding process to match the aforementioned nylon sheath. In addition, the clean lines of the box hide all of the aspects of operation which can be unsightly.

The third component complimenting the visual appeal is the interlocking cylindrical tubing that extends upward from the weatherproof housing. These tubes will be small in diameter and composed of polypropylene or a material with similar properties which can also be painted or pre-tinted to blend into the present invention's surroundings. Since the tubes will come in 1 ft sections, the user will be able to specify a height that suits his or her intended location in the most inconspicuous way possible. The device will be only as tall as the investment it's supposed to protect and this will serve to camouflage the unit.

Finally, the 360-degree rotating spray head will most likely be black in color and will be composed of polypropylene or a similar material. This component of the present invention will be affixed to the top of the adjustable tubing and taper to an extremely slim profile. This facet will be the only extremity which rises above the extent of the plant height horizon and due to the aforementioned characteristics, will most likely blend into the backdrop.

Another object of the present art is its superior functionality over the current products on the market or prior art in existence. This intended result is due to a number of facets including the adjustable height capabilities, the 360-degree rotating dispenser head and the programmable digital timer.

The present invention includes four 1 ft sections of cylindrical tubing which are interlocking. The rubber repellent tubing also has four sections equal in length with the exception of the first tube connected to the outlet of the rotary pump which is permanently affixed at one end inside the weatherproof housing. The tubes can be attached to one another via double male barbed couplings which the user will press fit into the loose ends of each rubber tube to create a linear length matching the height of the sections of PVC tubing which will be predetermined based upon the height of the intended plant life. This flexibility of height of operation allows the user to adjust to the plant life they wish to protect in order to achieve the optimum coverage.

The 360-degree dispenser head is also vital in the functionality of the present invention in that it enables the flow of repellent to be deflected over a large, 360-degree diameter using only a single nozzle. Some examples of prior art utilize multiple nozzles or orifices to achieve a high degree of coverage area, however these methods are inferior. Using multiple nozzles would either dilute the capable propelling power of the rotary pump resulting in decreased diameter of coverage or require a pump and power source that is not practical for a self-sufficient unit. Regardless, a true 360-degree diameter of coverage would not be possible unless there existed nozzles around the entire circumference resulting in a similar pitfall as described above. The 45-degree rotating deflector plate allows one stream from a single nozzle to be converted from a vertical stream into a perpendicular horizontal stream also providing the rotational force for the 360-degree range of motion therefore optimizing the efficiency of the present invention.

The programmable digital timer is an essential piece of the functionality of the present invention. Prior art has made reference to similar timers to be used in conjunction with those inventions, however the capabilities to specify the schedule have been at best limited. The examples of prior art utilized analog style timers where the scheduling options are based upon dials with pre-designated settings. For inventions of this nature, often the product should operate on the scale of minutes rather than hours. Most analog timers cannot be programmed to these specific parameters. Whereas a digital timer can maintain a place in time subject to the year, month and even account for daylight savings time. With a digital timer, the programming options are virtually unlimited, rendering the user fully in control of this present invention.

The final object of the present invention is to successfully implement each of the aforementioned objectives while at the same time doing so in a practical and marketable fashion.

The components which comprise the present invention are all fairly inexpensive and easy to manufacture. A primary issue with any invention is cost. It doesn't matter how good an invention is if the general population of consumers cannot afford it. Contributing to that factor is the circumstances associated with the issue this invention aims to overcome. The plant life in most consumers' yards is spread out so that one device will simply not suffice to fully protect their investment. Therefore they will most likely have to purchase multiple units thus increasing their cost exponentially. The present invention will hurdle that obstacle by enabling the average consumer to afford more than one unit.

Another factor is practicality in terms of ease of operation, convenience and product packaging. The present invention possesses a hinged door on the weatherproof housing that will give the user access to the battery compartment and the programmable digital timer. The door will contain a weatherproof material on the inside perimeter and an easy open clasp for opening and closing the product while simultaneously keeping the electric components dry and clean. There will be easy to understand programming instructions affixed to the inside of the door in case the manual is lost. And in addition to increased functionality mentioned above, the programmable digital timer will also enable the user to designate a schedule of operation that works best for them down to the minute. The repellent container will have a capacity of approximately 1 gallon. This will insure that the user will rarely have to refill the unit. Furthermore, the adjustable height capabilities also contribute to the overall marketability of the device due to the fact that pieces can be disassembled in order to fit within the smallest box possible. In an age where shelf space and fuel surcharges demand a premium for volume occupied, the smaller the package the better.

### BRIEF DESCRIPTION OF THE DRAWINGS

The following is a description of the various diagrams associated with the present invention. (Drawings are not to scale)

FIG. 1 is a full front elevation of the apparatus at its maximum height showing a cross section of the ground to illustrate the placement of the ground spike. In addition, a cross section of the repellent container is revealed to display the repellent itself and repellent tube extending to the bottom of the container.

FIG. 2 is a full side elevation of the apparatus at its maximum height. The weatherproof box is exposed in this view as well as the clasp for the weatherproof door. A cross section of the ground is again included to illustrate placement of the cylindrical ground spike.

FIG. 3 is an exploded view cross section of the weatherproof housing and the components therein which includes but is not limited to: The battery power source, the rotary motorized pump and the programmable digital timer.

FIG. 4 is an exploded view of the 360-degree dispenser head including but not limited to: the 45-degree angled deflector plate, “caliper style frame” and repellent tube extending from the top cylindrical section of adjustable PVC tubing.

### DESCRIPTION OF THE PREFERRED EMBODIMENT

With reference to the drawings associated with the present invention, the following is a description of each part labeled and its function in relation to said apparatus.

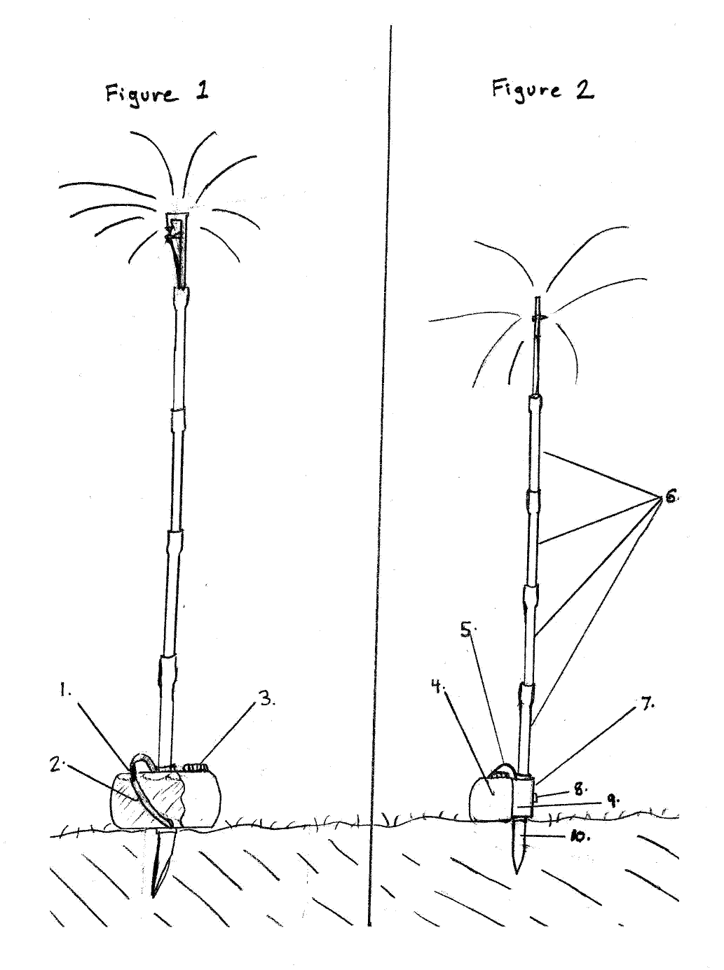

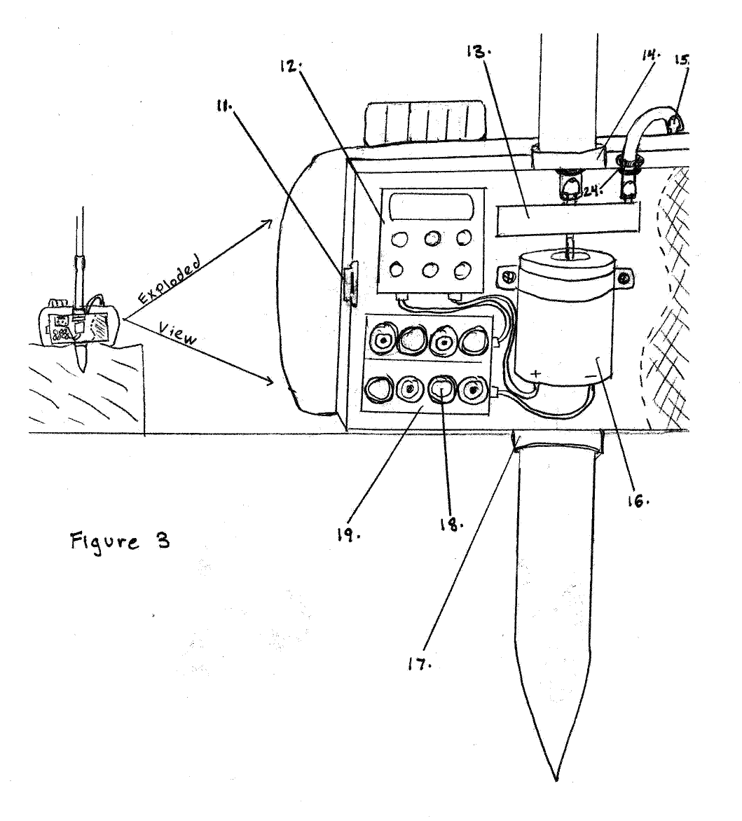

FIG. 1 displays a front elevation of the apparatus at its fully extended height. (Drawing is not done to scale) The ground is drawn as a cross section to show the cylindrical ground stake (FIG. 2, Component 10) submerged as an anchor point for the apparatus. The ground stake is made of durable weather-resistant, shatterproof material that can be forced into reasonably soft earth by applying downward pressure to the top of the weatherproof box labeled Component 9 in the side elevation of the apparatus in FIG. 2. The weatherproof box has a cylindrical fitting (FIG. 3, Component 17), adhered to the bottom with an inside diameter matching the outside diameter of the ground stake for purposes of coupling the two. The stake will work in conjunction with the 1-gallon capacity repellent container shown in FIG. 2, Component 4, to stabilize and anchor the unit in its intended place of operation. The container will contribute to the stability by two means: 1.: A low center of gravity. And 2.: A flat-bottomed surface that sits flush to the ground and acts as a counterpoint to the ground stake.

FIG. 1 has three labeled components that are visible from the front elevation. Component 3 is the large mouth cap which is used for access to the repellent container for purposes of refilling. The cap has a threaded interior diameter that reciprocally fits with the threaded opening at the top of the container. The cap also has a rubber gasket built into the underside in order to insure an airtight seal when screwed on tightly. Component 1, is the double male barbed polypropylene fitting which is located on the top of the repellent container. This fitting allows an airtight access point to the repellent by means of two rubber tubes. Component 2 is the inter-container repellent tube which extends to the bottom to insure efficient usage of the repellent contained therein. The outer-container repellent tube is pictured in FIG. 2 as Component 5. This component extends from Component 1, into the weatherproof housing (FIG. 2, Component 9) and is attached to the intake male barbed fitting of the rotary motorized pump (FIG. 3, Component 13). There is a rubber bushing with a hollow center fitted into the access point to the weatherproof housing (FIG. 3, Component 24). The rubber repellent tube will snuggly fit through the hollow center to insure a weather-tight seal.

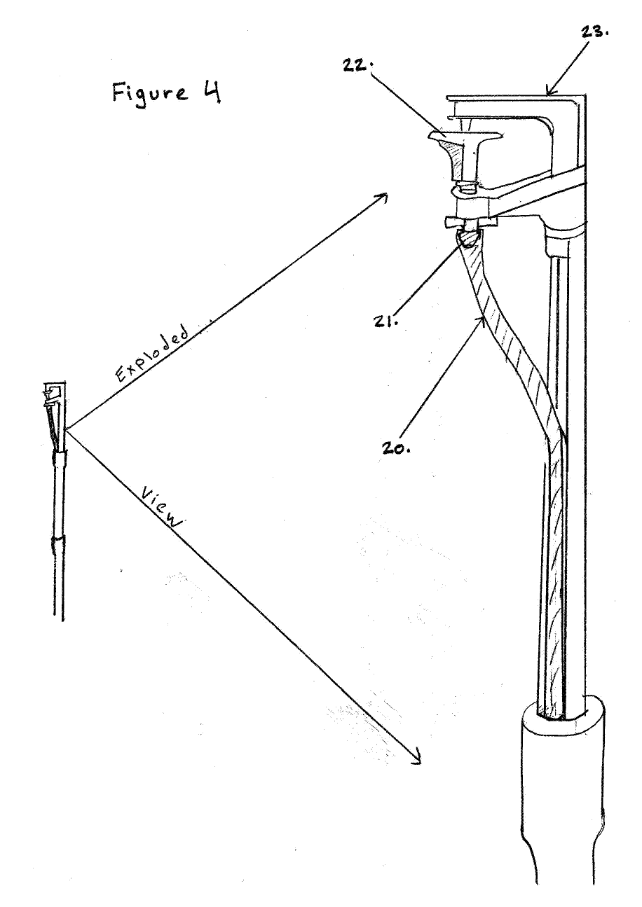

The next step of the operation primarily deals with the components pictured in FIG. 2. For the apparatus to function to its full capacity, the user must first decide a place of operation and utilize the ground stake to secure the unit and then they must decide on a height of operation that best suits the operation of the apparatus. The present invention will be most effective if the “caliper styled” dispenser head pictured as Component 23 in FIG. 4, is above the extent of the plant life it is designed to protect from deer and the like. Using the 1 ft cylindrical sections pictured in FIG. 2, Component 4, the user can accomplish this objective. After press fitting a number of cylindrical tubes together to achieve the desired height, they will interconnect the rubber repellent tubes included with the apparatus to complement the height of the cylindrical tubing. Connection of these rubber tubes will be facilitated by a double-male barbed polypropylene fitting which the user will press fit into the ends of each tube creating a coupling and resulting in a linear path for the repellent to flow. The user will then thread the rubber tubing through the center of cylindrical tubing and press fit the free end (FIG. 4, Component 20) at the top extent to the male barbed fitting shown in FIG. 4, Component 21. Finally, the linear section of cylindrical tubing and dispenser head will be press fit to a cylindrical fitting (FIG. 3, Component 14), located at the top of the weatherproof box possessing a tapered interior diameter matching that of the bottom end of tubing to facilitate a coupling.

The user is now ready to program the apparatus to a schedule that is convenient for them but also effective for protecting the plants. For this step, the user must unlatch the hinged door located on the weatherproof housing, (FIG. 2, Component 7). To accomplish this, the user must apply outward pressure to the clasp pictured in FIG. 3, Component 11, in order to release the door and swing it open. The inside perimeter of the door will possess a weatherproof material designed to create a tight seal when the door is in the closed position in order to keep wind and weather away from the electrical components. The programmable digital timer (FIG. 3, Component 12), will posses an internal battery which keeps the internal clock current independent of the main power source designated to power the rotary pump (FIG. 3, Component 16). At first use only, the user will have to set the date on the timer including year, month, days, hours, minutes and either am or pm. They will then program a schedule by selecting a day or multiple days in a week (An evenly spaced, biweekly cycle is recommended), for the unit to go on and off. The duration between the on and off cycle will be referred to as the “cycle time.”

Once programmed, the operation of the unit is facilitated by the components pictured in FIG. 3. When the programmable digital timer reaches its intended “on” time, the circuit will be completed from the battery power supply which is composed of 8 AA batteries, (FIG. 3, Component 18), bridged together to increase the voltage to 12 volts, by way of the battery box located in FIG. 3, Component 19, to the rotary motorized pump. The pump will then suck the repellent from the container via the repellent tubes previously described in FIGS. 1 and 2 and propel the flow of repellent up the rubber tubing and through the spray nozzle located just above Component 21 in FIG. 4, to a high pressure stream which will hit the 45-degree angled rotating deflector plate pictured in FIG. 4, Component 22. The upward force of the stream in relation to the 45-degree angle will create a horizontal spray of repellent extending outward from the dispenser head. Simultaneously, the upward force of the stream will also be converted into rotational force so that the horizontal stream described above will rotate 360-degrees. The diameter of repellent created will cover a large diameter (approx. 20 ft) thus protecting the plant life in that zone from the predators. The resulting operation is illustrated in both FIG. 1 and FIG. 2 by means of the cascading parabolic lines emanating from the top of the unit. The programmable timer will break the circuit at the programmed “off” time, therefore ceasing the operation of the unit until the next programmed “on” time is reached. Each time the unit turns on, there will be an inherent delay between the sounds of operation and the flow of repellent giving anyone in the proximity time to retreat.

1. A wildlife repellent dispersal system and apparatus comprised of: a container intended to hold a liquid wildlife repellent; a plurality of rubber tubing sections; a weatherproof housing; a ground spike; a means to propel said repellent independent of electrical outlets, solar clearance, or running water; adjustable height capabilities and a flow driven dispenser head capable of a 360-degree range of motion.

2. The apparatus from claim 1, wherein the container has a threaded cylindrical opening for purposes of refilling said container and cylindrical cap possessing the opposite threads and rubber gasket within the interior diameter intended to contain repellent in said container when both components are fitted together using a clockwise motion to tighten said components; a fitting composed of polypropylene or a material with similar properties adapted to the top of said container to provide an outlet by which said repellent can flow via a rubber tube that could be connected to said fitting both inside the container extending the bottom to insure efficient usage of repellent within said container and a similar rubber tube outside of the container to provide a path for the repellent's next phase of said apparatus. Both tubes shall be press fit to male barbed ends of said fitting which protrude on the interior and exterior of said container.

3. The apparatus from claim 2, wherein the container has a nylon fabric jacket encompassing said container.

4. The apparatus from claim 3, wherein the nylon jacket has a rectangular support insert composed of polypropylene or the like, riveted to the inside of said jacket for purposes of affixing the weatherproof housing described in claim 1 to said container.

5. The apparatus of claim 1, wherein the weather proof housing has a hinged access panel and said access panel has a rubber gasket or similar weatherproof material affixed to the inside perimeter.

6. The apparatus from claim 5, wherein the hinged access panel has a clasp opposite the hinged side intended to match up with an opposing clasp affixed to the edge of the weatherproof housing.

7. The apparatus from claim 1, wherein the means to propel the repellent is a rotary motorized pump within said weatherproof housing.

8. The apparatus from claim 7, further comprised of a power supply within said weatherproof housing connected to said motorized pump.

9. The apparatus from claim 8, wherein said power supply is battery operated.

10. The apparatus from claim 9, wherein the power supply is regulated by a programmable timer located within said weatherproof housing.

11. The apparatus from claim 10 wherein the programmable timer is digital in nature.

12. The apparatus from claim 1, wherein the ground spike is cylindrical in nature and is composed of PVC or a material with similar properties wherein said ground spike possesses a tapered outside diameter matching the inside diameter of a cylindrical fitting affixed to the bottom of the weatherproof housing referred in claim 1 so as to facilitate a coupling of both entities by means of a press fitting and thus providing a means to secure the unit to its intended place of operation.

13. The apparatus from claim 1, wherein four cylindrical tubes approximately 1 ft in length and composed of PVC or a material with similar properties, having a tapered outside diameter at one end matching the interior diameter of a cylindrical fitting affixed to the top of the weatherproof housing described in claim 1.

14. The apparatus from claim 13, wherein the opposite end of each cylindrical tube is flared to match the dimensions of the cylindrical fitting described in claim 13 so as to facilitate a variable linear coupling of each cylindrical tube by means of a press fitting.

15. The apparatus from claim 1, wherein four rubber tubes matching the diameter of those described in claim 2, are outfitted with a double male barbed coupling composed of polypropylene or material with similar properties, press fit to one end of each tube so as to facilitate a variable linear coupling of each cylindrical tube by means of a press fitting.

16. The apparatus in claims 13, 14 and 15, wherein both the cylindrical tubes and rubber tubes can be used in conjunction to facilitate the adjustable height capabilities described in claim 1.

17. The apparatus from claim 1, wherein the flow driven dispenser head is comprised of a fitting with a polypropylene nozzle at one end and a male barbed fitting composed of polypropylene or material with similar properties at the other end; affixed to a stake composed of a similar material, a 45-degree angled rotating deflector plate capable of a 360-degree range of motion and a “caliper styled” frame composed of similar materials to substantiate the aforementioned.

18. The apparatus from claim 17, wherein the projectile flow of repellent generated by the motorized pump and said battery operated power supply, regulated by said programmable variable timer, which is digital in nature; is dispensed from the nozzle described in claim 17, collides with the 45-degree angled rotating deflector plate converting the upward force to a perpendicular 360-degree cascade of repellent covering a large diameter in order to repel said wildlife from destroying plant life in said diameter.
